(19) United States
(12) Patent Application Publication
(10) Pub. No.: US 2023/0059588 A1
(43) Pub. Date: Feb. 23, 2023

(54) VEHICLE POSITION ESTIMATION

(71) Applicant: Telefonaktiebolaget LM Ericsson (publ), Stockholm (SE)

(72) Inventors: Yuxin ZHAO, LINKÖPING (SE); Alexandros PALAIOS, MOERS (DE); Reza MOOSAVI, LINKÖPING (SE); Vijaya YAJNANARAYANA, BANGALORE (IN); Henrik RYDÉN, STOCKHOLM (SE); Ursula CHALLITA, SOLNA (SE)

(21) Appl. No.: 17/797,948

(22) PCT Filed: Feb. 7, 2020
(86) PCT No.: PCT/EP2020/053202

§ 371 Date: Aug. 5, 2022

(51) Int. Cl. G01S 5/02; G06N 20/00

(52) U.S. Cl. CPC G01S 5/02585; G06N 20/00; G07C 5/008

(57) ABSTRACT

A computer implemented method is disclosed for estimating a position of a vehicle. The method comprises obtaining dynamic state information for the vehicle at a first time in a time sequence the dynamic state information comprising position information for the vehicle. The method further comprises receiving, from the vehicle, communication network information for the vehicle at a second time in the time sequence that is after the first time, wherein the communication network information comprises a result of a measurement carried out by the vehicle on a signal exchanged with the communication network. The method further comprises using a trained ML model to estimate a position of the vehicle at the second time in the time sequence on the basis of the obtained dynamic state information and received communication network information.

Also disclosed are a communication network node, a training agent and associated methods.

### TECHNICAL FIELD

The present disclosure relates to computing implemented methods for estimating a position of a vehicle and for training a Machine Learning model for estimating a position of a vehicle. The present disclosure also relates to a communication network node, a training agent and to a computer program and a computer program product configured, when run on a computer to carry out methods performed by a communication network node and training agent.

### BACKGROUND

Positioning information is useful for the vast majority of vehicles in private, public, commercial or industrial use. Positioning information is of particular importance for autonomous vehicles, as it is relied upon for many key functions of such vehicles, including self-navigation. Positioning information for vehicles may also be of great importance to control centres or control functions for autonomous vehicles, enabling proper supervision of vehicle behaviour and routing, including controlling vehicle convoys, confirming that delivery or other tasks are being performed according to pre-planned routes etc.

Positioning of autonomous vehicles is usually carried out using global satellite positioning systems such as GNSS/GPS. The Global Navigation Satellite System (GNSS) is an umbrella term that encompasses all global satellite positioning systems. One such system is the NAVSTAR Global Positioning System (GPS), which is now the most widely used GNSS in the world. While GNSS forms the basis of the majority of vehicle positioning methods, GNSS coverage is not perfect, and may be lost if a vehicle is outside of a coverage area, or loses connection to the GNSS system, for example in dense urban areas where high-rise buildings and tunnels may block the signal from satellites. Jamming technology for GNSS is also available, and GNSS jammers that block GNSS signals are available at relatively low cost.

Other methods for vehicle positioning, including for example vehicle sensor information based and map-assisted approaches, have been proposed for use in combination with GPS/GNSS based methods, or to compensate for when GNSS signal is lost.

Autonomous vehicles are usually equipped with multiple different sensors for sensing surrounding environments, including for example the Light Image Detecting and Ranging (LIDAR) sensor. However, these sensors are not intended for positioning use, and are usually applied to detect obstacles, maintain road position, avoid collisions etc. Inertial sensors can be helpful in positioning, as they can be used to compute velocity and acceleration, from which position information can be estimated using dead-reckoning. However, such estimations are not considered to be reliable, as the dead-reckoning is susceptible to accumulated errors. In addition, the sensor measurements depend heavily on vehicle dynamics, which vary in different environments, and measurement drift is not captured by vehicle deterministic dynamic models that are rarely updated. External positioning support, for example from GPS, can be added to counter the effect of accumulated errors and measurement drift, as is proposed in Toshihiro Aono, Kenjiro Fujii, Shintaro Hatsumoto, Takayuki Kamiya, “Positioning of vehicle on undulating ground using GPS and dead reckoning”, International Conference on Robotics & Automation Leuven, Belgium May 1998.

In order to compensate for the periodic or occasional loss of GNSS connectivity, map-based methods have also been proposed, according to which map information may be stored in the vehicle and taken into consideration, although such information may not always be available in advance, and requires significant storage capability and complex image processing methods in order to be exploited.

### SUMMARY

It is an aim of the present disclosure to provide a communication network node, a training agent and associated methods and computer readable media which at least partially address one or more of the challenges discussed above. It is a further aim of the present disclosure to provide a communication network node, a training agent and associated methods and computer readable media which cooperate to provide accurate positioning information for a vehicle, particularly in situations in which satellite based system coverage cannot be guaranteed.

According to a first aspect of the present disclosure, there is provided a computer implemented method for estimating a position of a vehicle, wherein the vehicle is operable to connect to a communication network. The method is performed by a node of the communication network and comprises obtaining dynamic state information for the vehicle at a first time in a time sequence, the dynamic state information comprising position information for the vehicle. The method further comprises receiving, from the vehicle, communication network information for the vehicle at a second time in the time sequence that is after the first time, wherein the communication network information comprises a result of a measurement carried out by the vehicle on a signal exchanged with the communication network. The method further comprises using a trained Machine Learning (ML) model to estimate a position of the vehicle at the second time in the time sequence on the basis of the obtained dynamic state information and received communication network information.

According to another aspect of the present disclosure, there is provided a computer implemented method for training a Machine Learning (ML) model for estimating a position of a vehicle, wherein the vehicle is operable to connect to a communication network. The method is performed by a training agent and comprises obtaining dynamic state information for the vehicle at a plurality of times forming a time sequence over a training period, wherein the dynamic state information comprises position information generated by a satellite positioning system. The method further comprises obtaining communication network information for the vehicle at the plurality of times over the training period, wherein the communication network information comprises a result of a measurement carried out by the vehicle on a signal exchanged with the communication network. The method further comprises using the obtained dynamic state information and communication network information to train a ML model for estimating a position of the vehicle.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method as set out in any one of the aspects or examples of the present disclosure.

According to another aspect of the present disclosure, there is provided a communication network node for estimating a position of a vehicle, wherein the vehicle is operable to connect to the communication network. The node comprises processing circuitry configured to cause the node to obtain dynamic state information for the vehicle at a first time in a time sequence, the dynamic state information comprising position information for the vehicle. The processing circuitry is further configured to cause the node to receive from the vehicle communication network information for the vehicle at a second time in the time sequence that is after the first time, wherein the communication network information comprises a result of a measurement carried out by the vehicle on a signal exchanged with the communication network. The processing circuitry is further configured to cause the node to use a trained Machine Learning (ML) model to estimate a position of the vehicle at the second time in the time sequence on the basis of the obtained dynamic state information and received communication network information.

According to another aspect of the present disclosure, there is provided a training agent for training a Machine Learning (ML) model for estimating a position of a vehicle, wherein the vehicle is operable to connect to a communication network. The training agent comprises processing circuitry configured to cause the training agent to obtain dynamic state information for the vehicle at a plurality of times forming a time sequence over a training period, wherein the dynamic state information comprises position information generated by a satellite positioning system. The processing circuitry is further configured to cause the training agent to obtain communication network information for the vehicle at the plurality of times over the training period, wherein the communication network information comprises a result of a measurement carried out by the vehicle on a signal exchanged with the communication network. The processing circuitry is further configured to cause the training agent to use the obtained dynamic state information and communication network information to train a ML model for estimating a position of the vehicle.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates phases of operation of methods according to the present disclosure;

FIG. 2 is a flow chart illustrating process steps in a method for estimating a position of a vehicle;

FIGS. 3a to 3d show a flow chart illustrating process steps in another example of method for estimating a position of a vehicle;

FIG. 4 is a flow chart illustrating process steps in a method for training an ML model for estimating a position of a vehicle;

FIGS. 5a to 5c show a flow chart illustrating process steps in another example of method for training an ML model for estimating a position of a vehicle;

FIG. 6 illustrates an example system in which the methods of FIGS. 2 to 5c may be carried out;

FIG. 7 illustrates data collection from autonomous vehicles;

FIG. 8 is a flow chart illustrating a training phase according to an example of the present disclosure;

FIG. 9 illustrates an overall procedure for training and using an ML model;

FIG. 10 illustrates an overall procedure for training and using ML models with a filtering algorithm;

FIG. 11 illustrates a running phase according to an example of the present disclosure;

FIG. 12 illustrates a prediction example;

FIG. 13 is a block diagram illustrating functional modules in an example communication network node;

FIG. 14 is a block diagram illustrating functional modules in another example of communication network node;

FIG. 15 is a block diagram illustrating functional modules in a training agent; and

FIG. 16 is a block diagram illustrating functional modules in another example of training agent.

### DETAILED DESCRIPTION

Aspects of the present disclosure provide a communication network node, training agent, and methods performed therein that use a combination of dynamic state information for a vehicle operable to connect to a communication network, and communication network information for the vehicle, to train a machine learning (ML) model for estimating a position of the vehicle, and to estimate a positon of the vehicle using such a model.

Machine learning algorithms seek to build a model that represents the relationship between a set of input data and a corresponding set of output data for a system. In one example of ML, during a training phase, input and output data are collected and used to train the ML model. The ML model may then be used during a prediction, or running phase, to predict an output value on the basis of an input value.

Connected autonomous vehicles usually follow predefined tracks or routes that are known in advance, and the trajectories of all vehicles are usually constrained in some way, most commonly by infrastructure such as roads, bridges, tunnels etc. ML methods may therefore be used to learn motion patterns for a vehicle on the basis of previous routes travelled and system constraints imposed by infrastructure and urban, semi urban and rural environments. An ML model that has learned motion patterns for a vehicle may therefore assist with estimating a position of the vehicle. Examples of the present disclosure propose to combine radio measurements from communication networks, and in some examples sensor measurements from vehicle sensors, with dynamic state information for the vehicle in order to estimate a vehicle position, even in GNSS deficient environments. The radio and sensor measurements can either be combined with a predicted position from an ML algorithm based on vehicle patterns, or the radio measurements can be used together with historical position information and sensor measurements as the machine learning input features, to improve the positioning accuracy of a combined ML model.

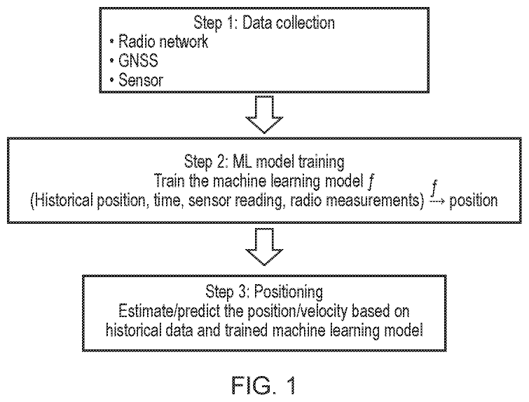

Example methods according to the present disclosure may follow three phases of operation, as set out in FIG. 1. In a first phase, labelled step 1, data is collected from a vehicle to enable training of the ML model. The data collected may include GNSS positioning information, radio measurements from a communication network to which a vehicle is connected, and sensor measurements from vehicle sensors. In a second phase, labelled step 2, an ML model f is trained to estimate a position of the vehicle on the basis of input data including historical position, time, sensor measurements and radio measurements. Finally, in a third phase labelled step 3, the trained ML model f is used to predict a live position of the vehicle based on available live input data.

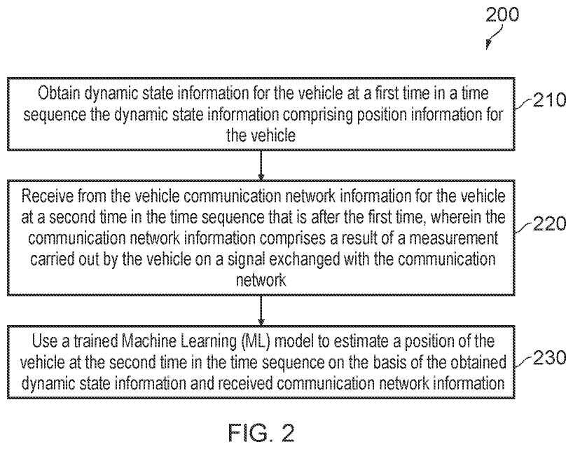

FIG. 2 is a flow chart illustrating process steps in a computer implemented method 200 for estimating a position of a vehicle in accordance with an example of the present disclosure, wherein the vehicle is operable to connect to a communication network. The method is performed by a node of the communication network, which may be a physical or virtual node and may be realised in a Radio Access Network, Core Network, Cloud, Edge Cloud or Fog deployment. In some examples, the node may comprise a Radio Access node of the communication network, such as a base station. Referring to FIG. 2, in a first step 210, the method 200 comprises obtaining dynamic state information for the vehicle at a first time in a time sequence, the dynamic state information comprising position information for the vehicle. In step 220, the method 200 comprises receiving, from the vehicle, communication network information for the vehicle at a second time in the time sequence that is after the first time, wherein the communication network information comprises a result of a measurement carried out by the vehicle on a signal exchanged with the communication network. In step 230, the method 200 comprises using a trained ML model to estimate a position of the vehicle at the second time in the time sequence on the basis of the obtained dynamic state information and received communication network information.

According to examples of the present disclosure, a signal exchanged with the communication network may be a signal sent to the communication network in the Uplink (UL) or received from the communication network in the downlink (DL). Example measurements may include radio signal strength, time of arrival, angle of arrival measurements, beam measurements, timing advance, Doppler shift etc. In some examples of the method 200, the communication network information for the vehicle may further comprise an identification of a communication network serving cell for the vehicle and/or neighbouring cells to the serving cell, which neighbouring cells can be detected by the vehicle.

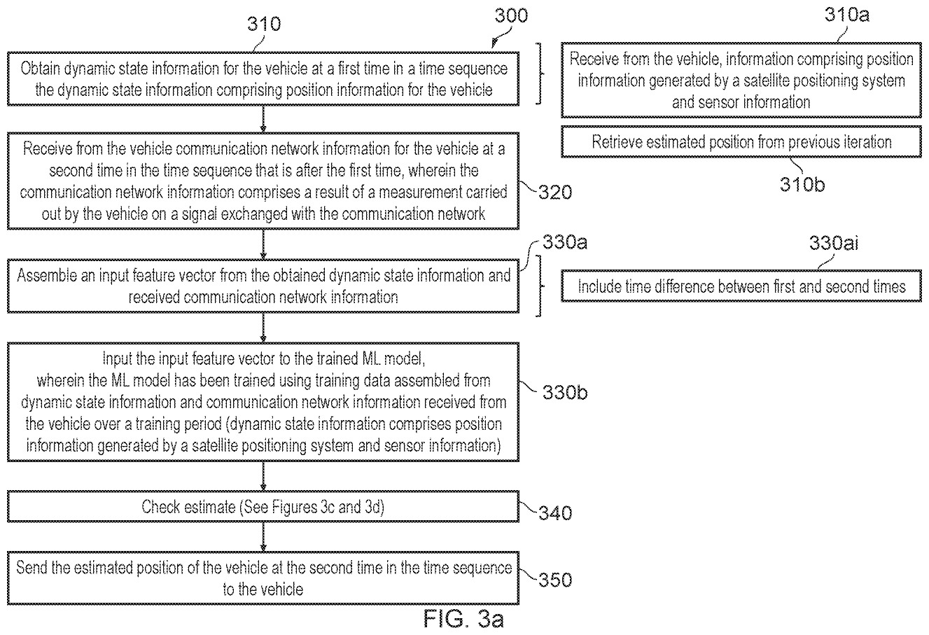

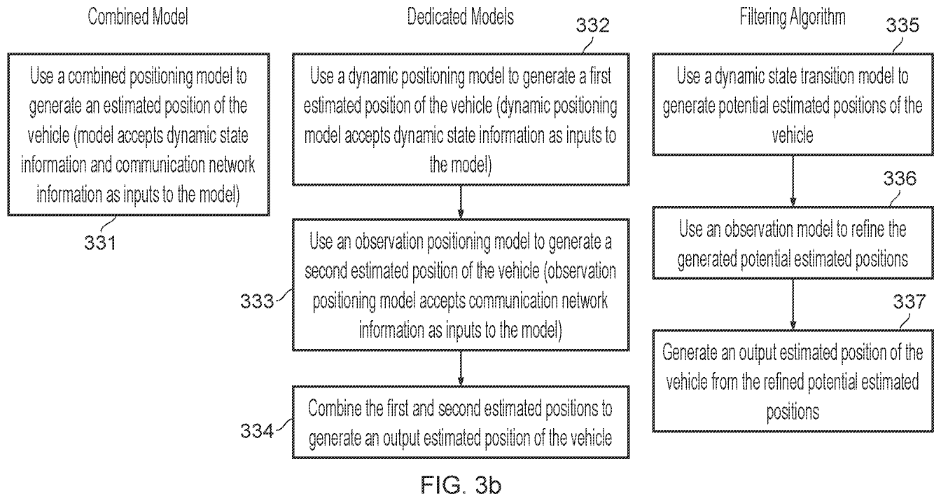

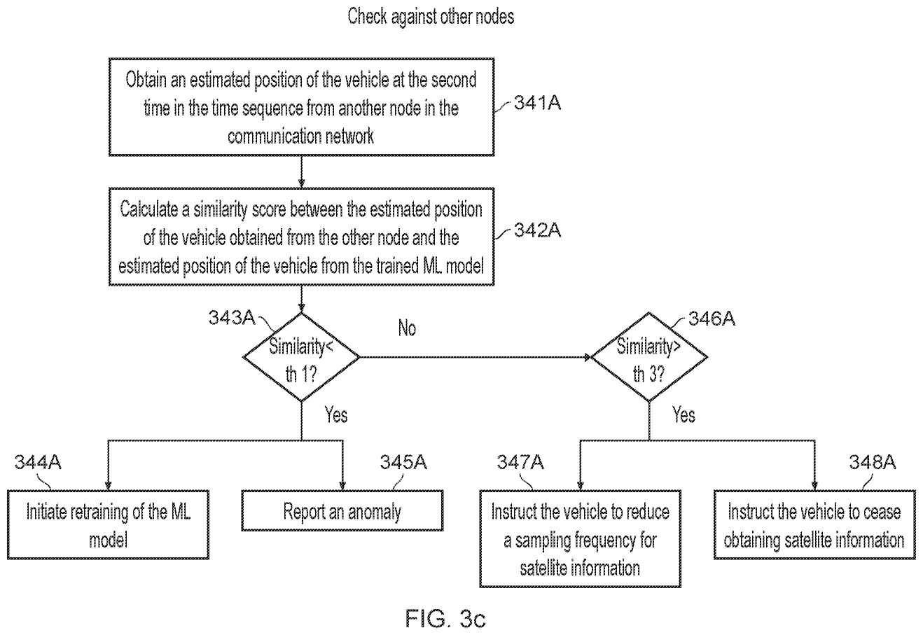

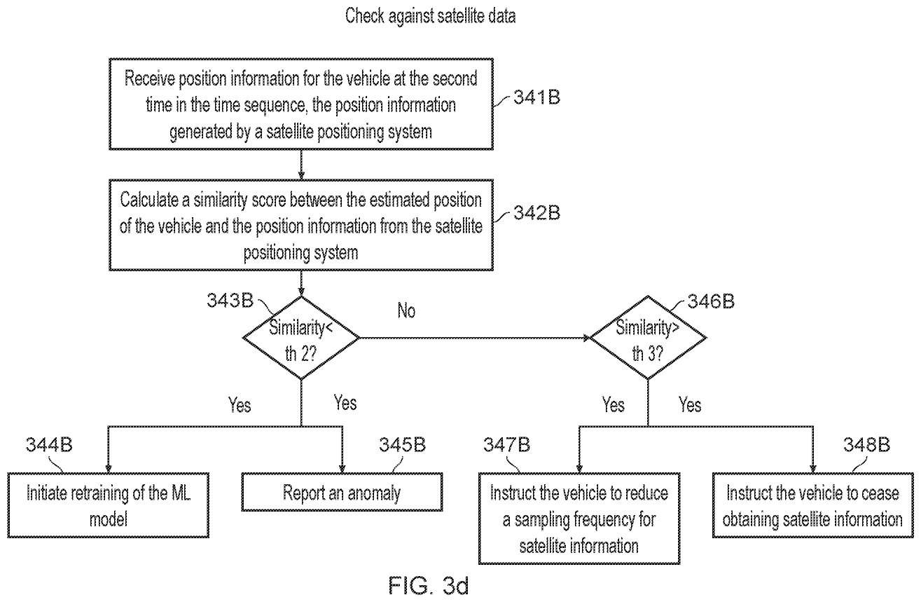

FIGS. 3a to 3d show a flow chart illustrating process steps in another example of computer implemented method 300 for estimating a position of a vehicle in accordance with examples of the present disclosure, wherein the vehicle is operable to connect to a communication network. The method 300 provides one example of how the steps of the method 200 may be implemented and supplemented to achieve the above discussed and additional functionality. As for the method 200 of FIG. 2, the method 300 is performed by a node of the communication network, which may be a physical or virtual node and may be realised in a Radio Access Network, Core Network, Cloud, Edge Cloud or Fog deployment. In some examples, the node may comprise a Radio Access node of the communication network, such as a base station.

Referring first to FIG. 3a, in a first step 310, the node obtains dynamic state information for the vehicle at a first time in a time sequence the dynamic state information comprising position information for the vehicle. FIG. 3a illustrates two different options for obtaining the dynamic state information. In a first option illustrated at 310a, the node may receive the dynamic state information from the vehicle, the dynamic state information comprising position information generated by a satellite positioning system. For the purposes of the present specification, a satellite positioning system comprises a system that uses satellites to provide autonomous geo-spatial positioning. As illustrated at 310a, the dynamic state information received from the vehicle may further comprise sensor information generated by a sensor on the vehicle, which may for example comprise a LIDAR sensor, speed sensor, acceleration sensor, etc. In a second option illustrated at 310b, the node may obtain dynamic state information for the vehicle at the first time in the time sequence by retrieving an estimated position of the vehicle at the first time in the time sequence, the estimated position of the vehicle at the first time in the time sequence generated during a previous iteration of the computer implemented method 300.

In step 320, the node receives, from the vehicle, communication network information for the vehicle at a second time in the time sequence that is after the first time, wherein the communication network information comprises a result of a measurement carried out by the vehicle on a signal exchanged with the communication network. As discussed above with reference to FIG. 2, a signal exchanged with the communication network may be a signal sent to the communication network in the Uplink (UL) or received from the communication network in the downlink (DL). Example measurements may include radio signal strength, time of arrival, angle of arrival measurements, beam measurements, timing advance, Doppler shift etc. In some examples of the method 300, the communication network information for the vehicle may further comprise an identification of a communication network serving cell for the vehicle and/or neighbouring cells to the serving cell, which neighbouring cells can be detected by the vehicle.

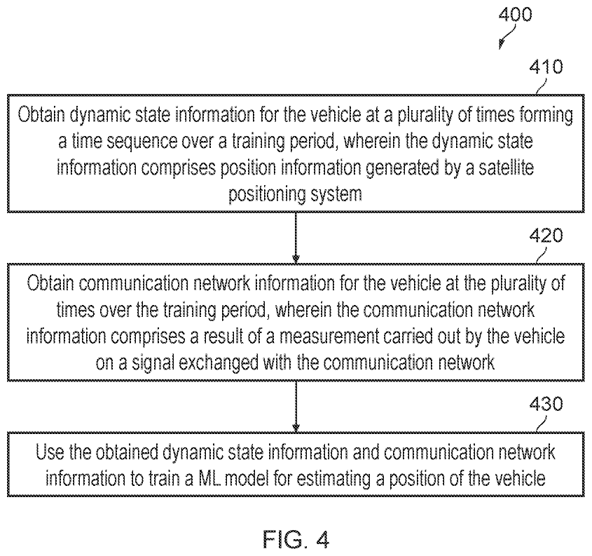

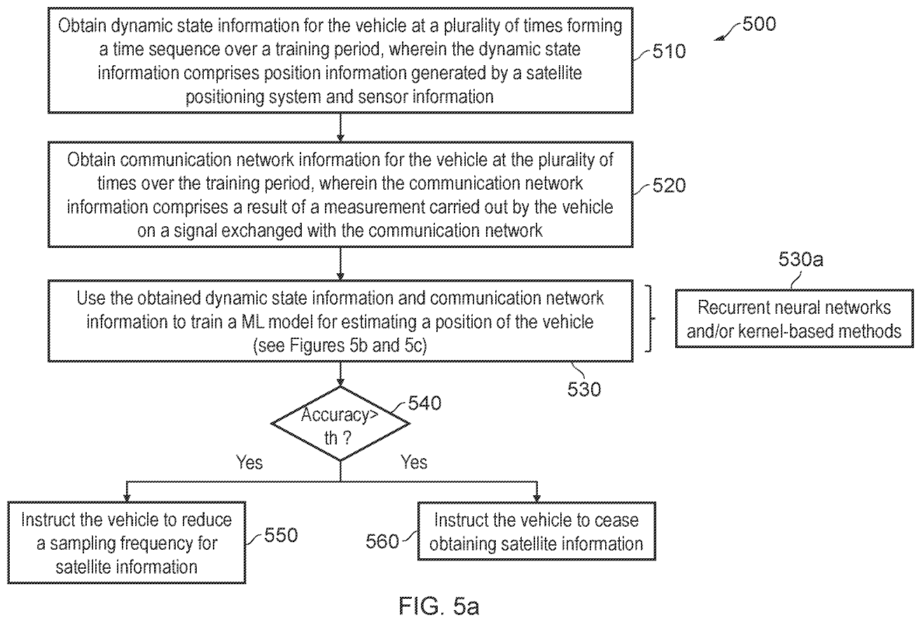

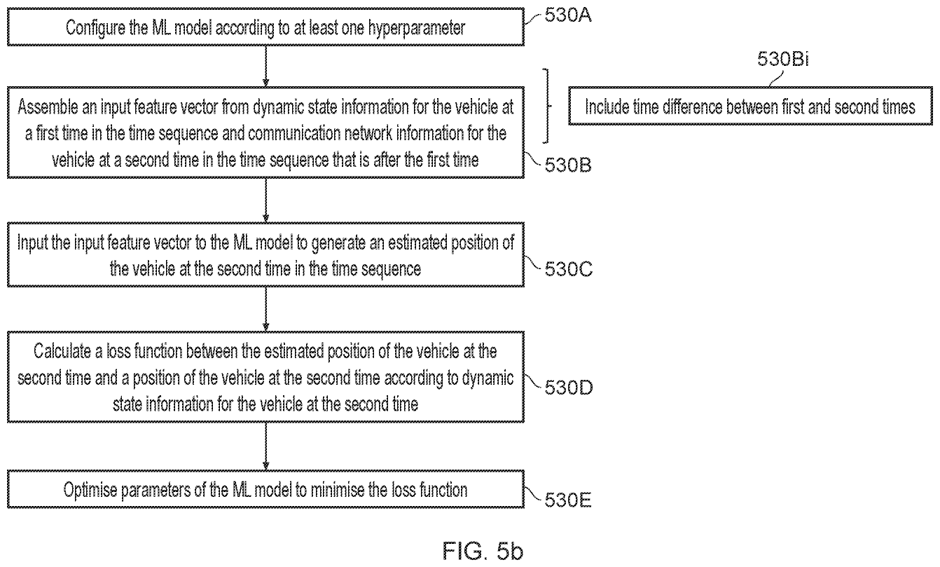

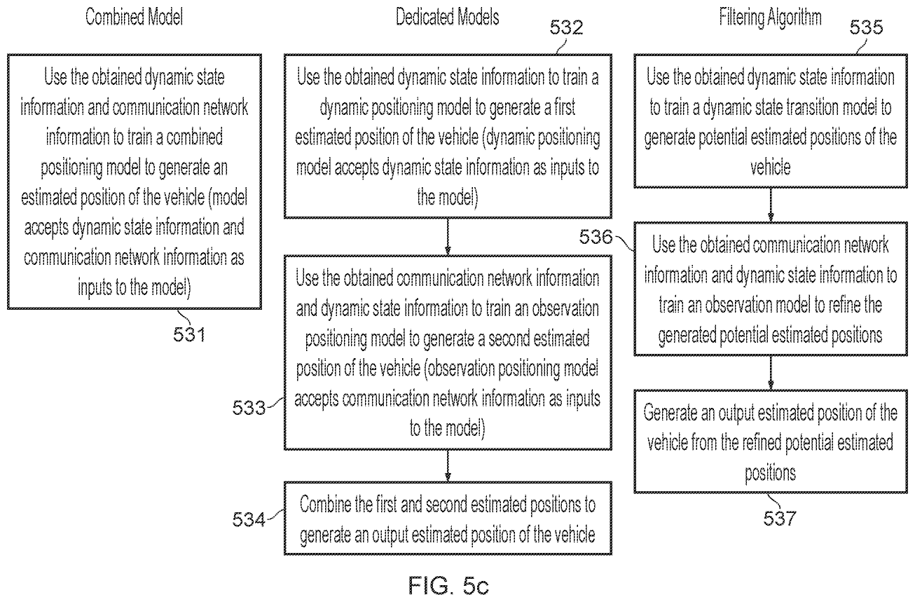

Having obtained the dynamic state information for the first time in the time sequence, and the communication network information for the second time in the time sequence, the node proceeds to use a trained ML model to estimate a position of the vehicle at the second time in the time sequence on the basis of the obtained dynamic state information and received communication network information. In the method 300, this is performed through steps 330a and 330b. In step 330a, the node assembles an input feature vector from the obtained dynamic state information and received communication network information, and may, as illustrated at 330ai, include in the input feature vector a time difference between the first time in the time sequence and the second time in the time sequence. In step 330b, the node inputs the input feature vector to the trained ML model. As illustrated at 330b, and discussed more fully below with reference to FIGS. 4 and 5a to 5c, the ML model has been trained using training data assembled from dynamic state information and communication network information received from the vehicle over a training period, wherein the dynamic state information received from the vehicle over the training period comprises position information generated by a satellite positioning system. The dynamic state information received from the vehicle over the training period may also comprise sensor information generated by a sensor on the vehicle.

The nature of the ML model used by the node to estimate a position of the vehicle at the second time may vary. Examples of ML models are discussed in greater detail below, and the corresponding method steps are illustrated in FIG. 3b, according to the nature of the model. As illustrated in FIG. 3b, the trained ML model used by the node may comprise a combined model, one or more dedicated models, or a filtering algorithm.

In examples of the method 300 in which a combined ML model is used, the step of using a trained ML model to estimate a position of the vehicle at the second time in the time sequence may be performed through step 331 by using a combined positioning model to generate an estimated position of the vehicle, wherein the combined positioning model is configured to accept dynamic state information and communication network information as inputs to the model. In such examples, the node may perform steps 330a (assembling an input vector) and 330b (inputting the input vector to the ML model) only once, as a single combined ML model is used to estimate a position based on both types of input data (dynamic state information and communication network information).

In examples of the method 300 in which dedicated ML models are used, the step of using a trained ML model to estimate a position of the vehicle at the second time in the time sequence may be performed through steps 332, 333 and 334. In step 332, the node uses a dynamic positioning model to generate a first estimated position of the vehicle, wherein the dynamic positioning model is configured to accept dynamic state information as inputs to the model. In step 333, the node uses an observation positioning model to generate a second estimated position of the vehicle, wherein the observation positioning model is configured to accept communication network information as inputs to the model. In step 334, the node combines the first and second estimated positions to generate an output estimated position of the vehicle. In some examples, step 334 may comprise calculating a weighted average of the first and second estimated positions. In such examples, the weights applied to each estimated positon may be adapted to account for expected errors in one or other of the dynamic or observation based models. In examples of the method 300 in which dedicated ML models are used, the node may perform steps 330a (assembling an input vector) and 330b (inputting the input vector to the ML model) twice, assembling and inputting an appropriate input vector for each of the dynamic and observation positioning models.

In examples of the method 300 in which a filtering algorithm is used, the step of using a trained ML model to estimate a position of the vehicle at the second time in the time sequence may comprise using the filtering algorithm to reduce error in an estimated position of the vehicle. Suitable filtering algorithms may include a Particle Filter, a Kalman filter or a point-mass filter. Using the filtering algorithm may comprise performing steps 335, 336 and 337. In step 335, the node uses a dynamic state transition model to generate potential estimated positions of the vehicle. In step 336, the node uses an observation model to refine the generated potential estimated positions, and in step 337, the node generates an output estimated position of the vehicle from the refined potential estimated positions.

As discussed above, different ML model types may be used for the different models envisaged in the examples illustrated in FIG. 3b. For example, parametric ML models, in which a form is selected in advance for the function to be learned, may be well suited to the dynamic positioning model. The dynamic positioning model is based on the kinetics of the vehicle, and represents a system that is relatively well defined, with known constraints. Taking for example speed, acceleration and position evolution over time, a linear model can be used to generate a useful representation of the evolution of the dynamic state of the vehicle over time. For the observation model, non-parametric ML models, in which no strong assumptions are made about the form of the function to be learned, may be most appropriate.

Referring again to FIG. 3a, after using the trained ML model to estimate position of the vehicle at the second time in the time sequence, the node may perform one or more cross checks on this estimate, as illustrated in FIGS. 3c and 3d. FIG. 3c illustrates method steps in performing a cross check against position estimates from one or more other communication network nodes which the vehicle may be able to detect and exchange signals with (Option A). FIG. 3d illustrates method steps in performing a cross check against satellite position information (Option B). Satellite position information may for example be used to check the accuracy of the ML estimate when such information is available, in order to increase confidence in the estimate when the satellite information is not available. In other examples, the ML model may be used as a check to ensure that the position information provided to the vehicle by the satellite positioning system is not faulty.

Referring first to FIG. 3c (Option A), the node may obtain in step 341A, an estimated position of the vehicle at the second time in the time sequence from one or more other nodes in the communication network. The other node or nodes may comprise neighbouring base stations and/or another virtual node that is receiving measurements from another base station etc. In step 342A, the node calculates a similarity score between the obtained estimated position of the vehicle at the second time in the time sequence from the one or more other nodes and the estimated position of the vehicle at the second time in the time sequence from the trained ML model. In step 343A, the node checks whether or not the similarity score is below a first threshold value Th1, which indicates acceptable performance of the ML model based on this comparison. If the calculated similarity score is below the first threshold value, the node may either initiate retraining of the ML model in step 344A or report an anomaly in step 345A. In some examples, the node may track the evolution of the similarity score and take this evolution into account in deciding whether to retrain the model and/or report an anomaly. For example, a gradual degradation of the similarity score over time may indicate that the vehicle and its environment have evolved such that the ML model is no longer adequately representing the evolution of the vehicle in the environment, suggesting the ML model should be retrained. A sudden degradation of the similarity score may indicate an anomaly that should be reported. In further examples, in which a comparison may be made with position estimates obtained from several other nodes an anomaly may be reported if one of the estimates differs significantly from the others.

If in step 343A the calculated similarity score is above the first threshold value, the node may additionally check, in step 346A, whether or not the calculated similarity score is above a third threshold value Th3, which indicates excellent performance of the ML model based on this comparison. If the calculated similarity score is above the third threshold value Th3, the node may instruct the vehicle to reduce a sampling frequency with which the vehicle obtains position information from the satellite positioning system in step 347A, or may instruct the vehicle to cease obtaining position information from the satellite positioning system for a period of time in step 348A. The period of time may be finite, until further notice or until a condition is fulfilled indicating the accuracy of the estimated position has reduced below the third threshold value.

The value of the first and third thresholds may be selected according to individual use cases, taking account of the capabilities of the vehicle and its requirements for accurate position information. The logic determining what actions to take if a similarity score exceeds or falls below a threshold may also take such factors into account.

Referring now to FIG. 3d (Option B), the node may receive from the vehicle in step 341B dynamic state information for the vehicle at the second time in the time sequence, wherein the dynamic state information comprises position information generated by a satellite positioning system, and may additionally comprise sensor information generated by a sensor on the vehicle. In step 342B, the node calculates a similarity score between the position information generated by a satellite positioning system for the vehicle at the second time and the estimated position of the vehicle at the second time from the ML model. In step 343B, the node checks whether or not the similarity score is below a second threshold value Th2, which indicates acceptable performance of the ML model based on this comparison. If the calculated similarity score is below the second threshold value, the node may either initiate retraining of the ML model in step 344B or report an anomaly in step 345B. As discussed above for the check against estimates from other nodes, in some examples the node may track the evolution of the similarity score and take this evolution into account in deciding whether to retrain the model and/or report an anomaly. In some examples, the node may initiate disconnection of the vehicle from the satellite positioning system if the tracked similarity score indicates a problem with the satellite positioning data.

In further examples (not shown) the node may use a check performed against estimates from other nodes in accordance with Option A to determine whether to retrain the ML model or report an anomaly on the basis of a check against satellite position information in accordance with Option B. The node may for example obtain an estimated position of the vehicle at the second time in the time sequence from one or more other node in the communication network, and use the obtained estimated position of the vehicle from the other node(s) in the communication network following the comparison in step 343B to determine whether to initiate retraining of the ML model (if the estimates from other nodes suggest the ML model is at fault) or report an anomaly (if the estimates from other nodes suggest the satellite positioning system information is at fault).

Referring still to FIG. 3d, if in step 343B the calculated similarity score is above the second threshold value, the node may additionally check, in step 346B, whether or not the calculated similarity score is above a third threshold value Th3, which indicates excellent performance of the ML model based on this comparison. If the calculated similarity score is above the third threshold value Th3, the node may instruct the vehicle to reduce a sampling frequency with which the vehicle obtains position information from the satellite positioning system in step 347B, or may instruct the vehicle to cease obtaining position information from the satellite positioning system for a period of time in step 348B. The period of time may be finite, until further notice or until a condition is fulfilled indicating the accuracy of the estimated position has reduced below the third threshold value.

As discussed above with reference to FIG. 3c, the value of the second and third thresholds may be selected according to individual use cases, taking account of the capabilities of the vehicle and its requirements for accurate position information. The logic determining what actions to take if a similarity score exceeds or falls below a threshold may also take such factors into account.

Referring again to FIG. 3a, having checked the accuracy of the estimates position generated by the trained ML mode, the node may, in step 350, send the estimated position of the vehicle at the second time in the time sequence to the vehicle. In some examples, the node may send the estimated position before checking its accuracy. For example, the node may update its position estimate on the basis of newly received input data with a first frequency f1, appropriate to the requirements of the vehicle for up to date position information, and may check the accuracy of estimated positions with frequency f2, which may be lower than frequency f1.

The methods 200 and/or 300, performed by a communication network node such as a base station, may be complimented by methods 400, 500 performed by a training agent, as illustrated in FIGS. 4 and 5a to 5c and discussed below.

FIG. 4 is a flow chart illustrating process steps in a computer implemented method 400 for training an ML model for estimating a position of a vehicle in accordance with examples of the present disclosure, wherein the vehicle is operable to connect to a communication network. The method is performed by a training agent, which may for example comprise an application or function, which may be instantiated within a Radio Access node, Core network node or in a cloud or fog deployment. Referring to FIG. 4, in a first step 410, the method 400 comprises obtaining dynamic state information for the vehicle at a plurality of times forming a time sequence over a training period, wherein the dynamic state information comprises position information generated by a satellite positioning system. The time sequence may span some or all of the training period. In step 420, the method 400 comprises obtaining communication network information for the vehicle at the plurality of times over the training period, wherein the communication network information comprises a result of a measurement carried out by the vehicle on a signal exchanged with the communication network. In step 430, the method 400 comprises using the obtained dynamic state information and communication network information to train a ML model for estimating a position of the vehicle.

As discussed above with reference to FIGS. 2 and 3a, according to examples of the present disclosure, a signal exchanged with the communication network may be a signal sent to the communication network in the Uplink (UL) or received from the communication network in the downlink (DL). Example measurements may include radio signal strength, time of arrival, angle of arrival measurements, beam measurements, timing advance, Doppler shift etc. In some examples of the method 400, the communication network information for the vehicle may further comprise an identification of a communication network serving cell for the vehicle and/or neighbouring cells to the serving cell, which neighbouring cells can be detected by the vehicle.

FIGS. 5a to 5c show a flow chart illustrating process steps in another example of computer implemented method 500 for training an ML model for estimating a position of a vehicle in accordance with examples of the present disclosure, wherein the vehicle is operable to connect to a communication network. The method 500 provides one example of how the steps of the method 400 may be implemented and supplemented to achieve the above discussed and additional functionality. As for the method 400 of FIG. 4, the method is performed by a training agent, which may for example comprise an application or function, which may be instantiated within a Radio Access node, Core network node or in a cloud or fog deployment.

Referring initially to FIG. 5a, in a first step 510, the training agent obtains dynamic state information for the vehicle at a plurality of times forming a time sequence over a training period, wherein the dynamic state information comprises position information generated by a satellite positioning system. The time sequence may span some or all of the training period. In some examples, the dynamic state information may further comprise sensor information generated by a sensor on the vehicle. In step 520, the training agent obtains communication network information for the vehicle at the plurality of times over the training period, wherein the communication network information comprises a result of a measurement carried out by the vehicle on a signal exchanged with the communication network. In step 520, the training agent uses the obtained dynamic state information and communication network information to train an ML model for estimating a position of the vehicle. As illustrated at 530a, this may comprise using at least one of recurrent neural networks and/or kernel-based methods. As discussed in further detail below, in examples in which multiple ML models are trained, different training methods may be used for the different models.

In step 540, the training agent checks whether or not an accuracy of the trained ML model is above a threshold value. If the accuracy of the trained ML model is above a threshold value, the training agent may instruct the vehicle to reduce a sampling frequency with which the vehicle obtains position information from the satellite positioning system in step 550 or instruct the vehicle to cease obtaining position information from the satellite positioning system for a period of time, which may be finite or condition based. In some examples, the training agent may trigger retraining of the ML model under different conditions, including a fixed time period, prediction performance threshold, etc. In other examples, retraining of the ML model may be initiated by a communication network node that is using the model, as discussed above. The training agent may supply the trained model to the communication network node, and may receive performance updates for the model from the communication network node.

FIG. 5b illustrates in greater detail the method steps that may be involved in using the obtained dynamic state information and communication network information to train an ML model for estimating a position of the vehicle. Referring to FIG. 5b, in a first step 530A, the training agent configures the ML model according to at least one hyperparameter. The training agent then, in step 530B, assembles an input feature vector from dynamic state information for the vehicle at a first time in the time sequence and communication network information for the vehicle at a second time in the time sequence that is after the first time. As illustrated at 530Bi, the input feature vector may further comprise a time difference between the first time and the second time. In step 530C, the training agent inputs the input feature vector to the ML model to generate an estimated position of the vehicle at the second time in the time sequence. The training agent then, in step 530D, calculates a loss function between the estimated position of the vehicle at the second time and a position of the vehicle at the second time according to dynamic state information for the vehicle at the second time. In step 530E, the training agent optimises parameters of the ML model to minimise the loss function.

As discussed above with reference to FIG. 3b, and illustrated in FIG. 5c, the ML model trained by the training agent may comprise a combined model, one or more dedicated models, or a filtering algorithm.

In examples of the method 500 in which a combined ML model is used, the step 530 of using the obtained dynamic state information and communication network information to train a ML model for estimating a position of the vehicle may be performed through step 531 by using the obtained dynamic state information and communication network information to train a combined positioning model to generate an estimated position of the vehicle, wherein the combined positioning model is configured to accept dynamic state information and communication network information as inputs to the model. In such examples, the training agent may perform one or more iterations of steps 530A to 530E for the single combined ML model.

In examples of the method 500 in which dedicated ML models are used, the step 530 of using the obtained dynamic state information and communication network information to train a ML model for estimating a position of the vehicle may be performed through steps 532, 533 and 534. In step 532, the training agent uses the obtained dynamic state information to train a dynamic positioning model to generate a first estimated position of the vehicle, wherein the dynamic positioning model is configured to accept dynamic state information as inputs to the model. In step 533, the training agent uses the obtained communication network information and dynamic state information to train an observation positioning model to generate a second estimated position of the vehicle, wherein the observation positioning model is configured to accept communication network information as inputs to the model. In step 534, the training agent combines the first and second estimated positions to generate an output estimated position of the vehicle. In some examples, step 534 may comprise calculating a weighted average of the first and second estimated positions. In such examples, the weights applied to each estimated positon may be adapted to account for expected errors in one or other of the dynamic or observation based models. In examples of the method 500 in which dedicated ML models are used, the training agent may perform one or more iterations of the steps 530A to 530E for each of the dynamic and observation positioning models. The training agent may additionally use dynamic positioning information to refine weights for the weighted average.

In examples of the method 500 in which a filtering algorithm is used, the step 530 of using the obtained dynamic state information and communication network information to train an ML model for estimating a position of the vehicle may comprise using a filtering algorithm to reduce error in an estimated position of the vehicle. Suitable filtering algorithms may include a Particle Filter, a Kalman filter or a point-mass filter. Using the filtering algorithm may comprise performing steps 535, 536 and 537. In step 535, the training agent uses the obtained dynamic state information to train a dynamic state transition model to generate potential estimated positions of the vehicle. In step 536, the training agent uses the obtained communication network information and dynamic state information to train an observation model to refine the generated potential estimated positions. In step 537, the training agent generates an output estimate position of the vehicle from the refined potential estimated positions.

FIGS. 2 to 5c described above illustrate methods carried out by a communication network node and training agent, which may cooperate to provide estimates of vehicle position base both on dynamic state information or the vehicle and on communication network information. There now follows a discussion of how aspects of these methods may be implemented in system comprising a vehicle, a communication network node and a training agent.

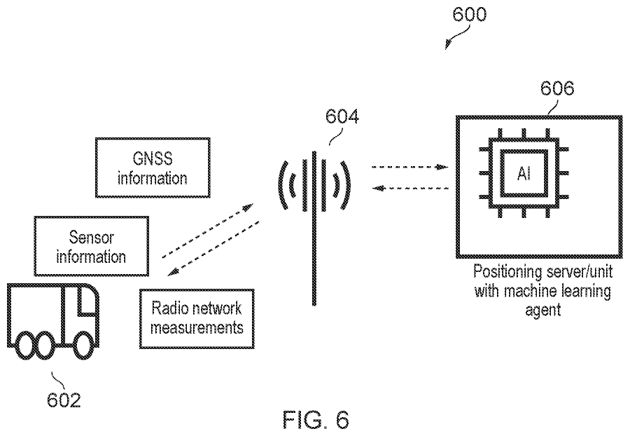

FIG. 6 illustrates an example system 600 comprising a vehicle 602 which is operable to connect to a communication network, a base station 604 of the communication network, and a virtual node 606 of the communication network, within which is instantiated a training agent. The virtual node 606 may be deployed within the base station 604, within a central computation entity in the core network or in the cloud. It will be appreciated that the virtual node 606 is merely one example of a communication network node that may implement examples of the present disclosure. While the example of a virtual node is referred to in the following discussion, it will be appreciated that the following discussion applies equally to any other logical or physical realisation of a communication network node. Wireless communication is established between the vehicle 602 and the communication network via the base station 604. The base station 604 is connected to the core network of the communication network, and may also be connected to the cloud. The communication network may comprise a plurality of base stations, although only a single base station 604 is illustrated for clarity. The vehicle 602 receives and measures radio signals from the base station 604, as well as from neighbouring base stations (not shown). The vehicle is also equipped with a GNSS receiver and inertial sensors. The vehicle reports via the base station 604 to the virtual node 606 a range of information including: sensor measurements from the sensors incorporated in the car, the positioning information provided by the GNSS, and radio measurements on signals exchanged with base stations. This information is assembled by the virtual node 606 into features for training of one or more ML models or for input to one or more trained ML models in order to generate an estimated position of the vehicle 602.

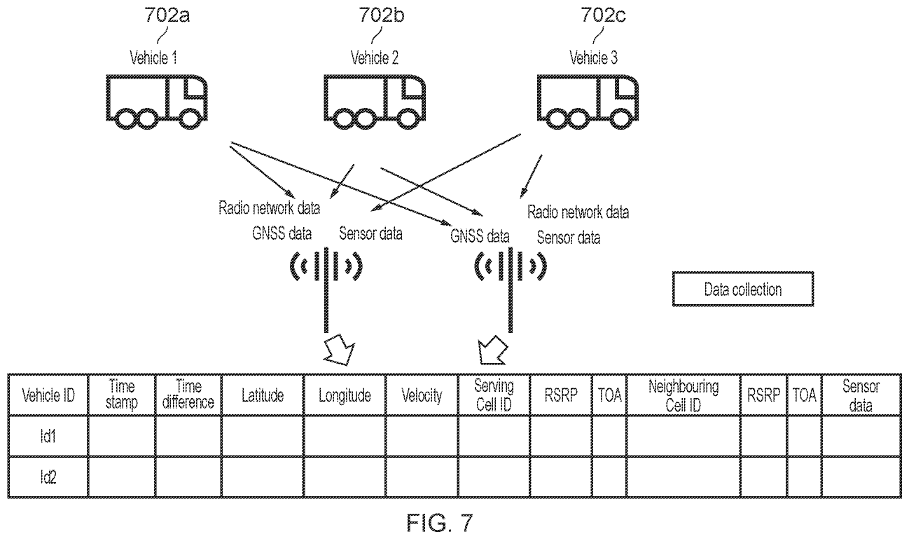

Data collection from each of a plurality of autonomous vehicles 702 is illustrated in FIG. 7. The autonomous vehicles 702 are connected to a wireless radio network and can communicate with the network while driving. As the vehicles are driving, a set of data or features is collected which may include known positions from GNSS or other sources, radio measurements, sensor measurements, performance indicators that are associated with different positions etc. The features are stored in the network and used for training of a machine learning model. The features can be stored for instance as illustrated in FIG. 7. Examples of features that may be received from the vehicles, extracted and stored may include:
A Vehicle Identifier that which uniquely identifies each vehicle. Each vehicle can be considered as a UE if it is equipped with a valid SIM card.
A time stamp indicating the time at which the features are recorded or measured.
Radio measurements including: radio signal strength, time of arrival, angel of arrival measurements, beam measurements, timing advance, Doppler shift etc. The radio measurements may comprise both uplink and downlink measurements.
Geographical location of the vehicle provided by GNSS whenever it is available.
Time difference between two consecutive time stamps, which can be computed by taking the difference between two consecutive time stamps.
Sensor information from the vehicle including speed, acceleration, LIDAR, etc.
Communication network serving and neighbouring cell identifiers.

Additional examples of features that can be stored may be found in ETSI TS 102 894-2 V1.2.1. Intelligent Transport Systems (ITS); Users and applications requirements; Part 2: Applications and facilities layer common data dictionary (for example subsection 4.3.2). A report containing the collected features may be either configured, for example sent by a vehicle to the network in a scheduled or periodic manner, or provided on request from the network.

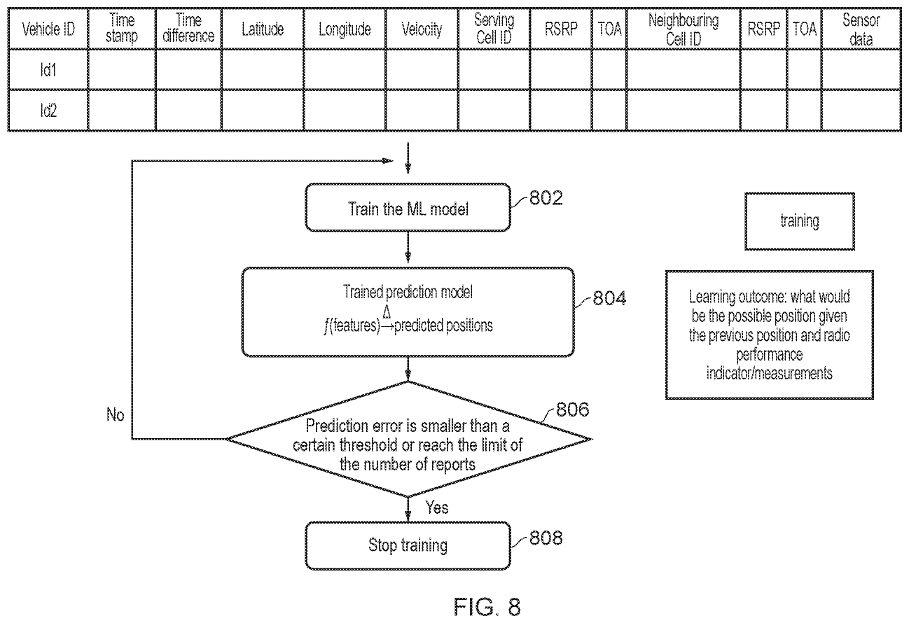

FIG. 8 is a flow chart illustrating a training phase, during which the training agent in the communication network virtual node trains an ML model to estimate a position of a vehicle on the basis of the data collected. Referring to FIG. 8, a first training iteration is performed in step 802, resulting in a trained prediction model 804 that converts input features to a predicted position. In step 806, a check is made as to whether a prediction error (with respect for example to GNSS based position information) is below a threshold value, or an iteration limit has been reached, or an amount of data has reached the limit of the database. If any one or more of these conditions is met, the training stops at step 808. Otherwise the training may continue.

As discussed above, the ML model may comprise a combined ML model, dedicated dynamic and observational positioning models, or a filtering algorithm.

One example for training a combined model can be expressed as:

$$\text{?}$$

$$\text{?} \text{indicates text missing or illegible when filed}$$

where [symbol] is the position at time [symbol] is the position at previous time stamps, Δt is the time difference between two consecutive time stamps, RSRPₜ¹, TOAₜ¹, RSRPₜ², TOAₜ² are relevant radio measurements at time t, and [symbol] is independent noise. The machine learning model is denoted by f.

Another example for training dedicated dynamic and observational positioning models may expressed as:

$$\text{?}$$

$$\text{?}$$

$$\text{?} \text{indicates text missing or illegible when filed}$$

The dynamic and observational models are each trained, and, in the positioning phase, the prediction outputs from the two models are combined to produce a final position estimation. The combination may for example comprise a weighted average.

Suitable methods for training the models may include recurrent neural networks, and/or kernel-based methods including for example Gaussian processes or principal component analysis. It will be appreciated that, as noted above, in the case of separate dynamic and observational positioning models, different machine learning methods can be used to train models f and h, respectively.

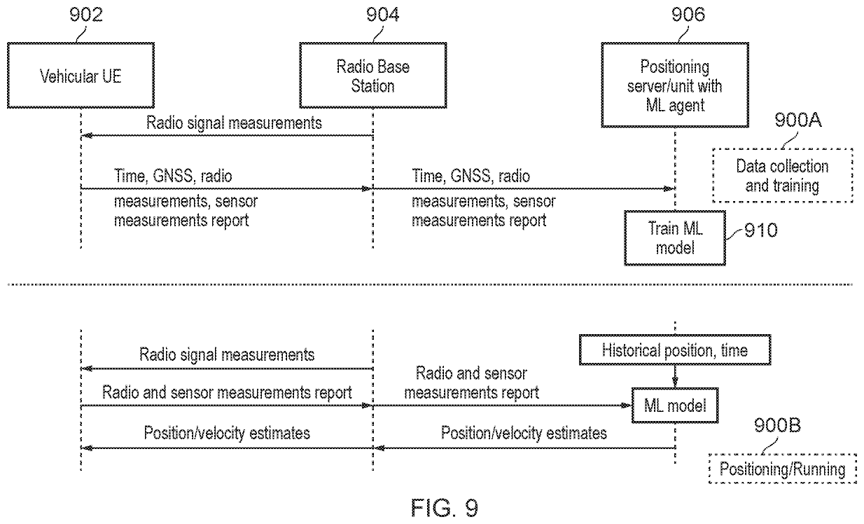

FIG. 9 illustrates an overall procedure for training and using an ML model as set out above (either combined or dynamic and observation). In a data collection and training phase 900A, information including GNSS, radio measurements and sensor data is provided by the vehicle 902 via the base station 904 to the virtual node 906, allowing for training of the ML model 910. In a running phase 900B, radio and sensor measurements are provided by the vehicle 902 via the base station 904 to the virtual node 906. The virtual node 906 inputs this information, together with historical positioning information (from GNSS or from a previous prediction), to the trained ML model and generates an estimated position of the vehicle that is provided back to the vehicle. The ML model may additionally provide a velocity estimate.

In another example, filtering such as a particle filter, Kalman filters, point-mass filter etc. may be used to combine information or reduce errors in the estimation. This may be particularly applicable to scenarios in which a time-series of measurements is reported, and the vehicle requires regulated positioning for a certain time period.

In order to apply a filter, the virtual node formulates the estimation problem into a dynamic state transition function and a measurement function:

xₜ=f(xₜ₋₁,nₜ) (1)

yₜ=h(xₜ,θₜ) (2)

Where the states xₜ=(pₜ,vₜ, . . . ), the measurements yₜ=(RSRPₜ¹, TOAₜ¹, RSRPₜ², TOAₜ² . . . ), and nₜ and θₜ are random noise in the models. It will be appreciated that the function h in equation (2) above is different to the function h introduced earlier, as the input to the function h in equation (2) is position, and the outputs are measurements.

In many connected vehicles, the trajectory of the connected vehicle is known in advance. This advance knowledge can be used to train the dynamic state-evolution equation (equation (1) in the above example, in which the state could be position evolution with time). The dynamic state-evolution equation can be trained in the machine learning agent, using for example recurrent neural networks, based on historical position data and the time information. Observation is also modelled by another machine learning agent (equation (2) in the above example), with the machine learning methods being determined on the basis of the observation type. Observation is then filtered, together with the trained position evolution, using the Kalman filters, particle filters or other filtering algorithm to reduce error.

Taking particle filter as one example, the general procedure to estimate the position at current time t is summarised below:
Initialize the filter (assume that the position at time t−1 is known, and is denoted by xₜ₋₁): draw random particles/samples around the true position, xₜ₋₁, for example xₜ₋₁ⁱ˜xₜ₋₁+randomnoise, i=1, . . . , N.
Predicted positions, also called particles/samples (constrained by the dynamic model in equation (1)): xₜ₋₁ⁱ˜f(xₜ₋₁ⁱ,nₜ), i=1, . . . , N. xₜ^{i=1, . . . ,N} are the predicted positions, and xₜ₋₁ⁱ is the i-th particle at time t−1.
Compute the probability of each predicted position using the measurement model given in equation (2): wₜⁱ=wₜ₋₁ⁱp(yₜ|xₜⁱ), wherein wₜ₋₁ⁱ is the weight of i-th predicted position at time t−1.
Estimate the current position as a weighted sum of all predicted positions:

$${\hat{x}}_{t} = {\sum }_{i} ( \frac{p ( {y}_{t} \vert {x}_{t}^{i} )}{{\sum }_{i} p ( {y}_{t} \vert {x}_{t}^{i} )} ) {x}_{t}^{i}$$

Repeat this procedure as time evolves.

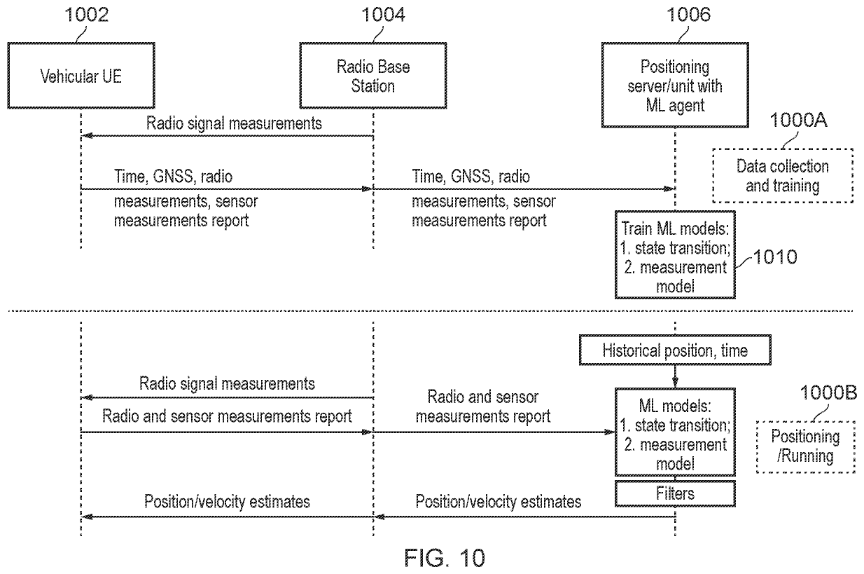

FIG. 10 illustrates an overall procedure for training and using ML models with a filtering algorithm. In a data collection and training phase 1000A, information including GNSS, radio measurements and sensor data is provided by the vehicle 1002 via the base station 1004 to the virtual node 1006, allowing for training of the ML models 1010. In a running phase 1000B, radio and sensor measurements are provided by the vehicle 1002 via the base station 1004 to the virtual node 1006. The virtual node 1006 inputs this information, together with historical positioning information (from GNSS or from a previous prediction), to the trained ML models, filters to reduce error and generates an estimated position of the vehicle that is provided back to the vehicle.

It will be appreciated that periodic, scheduled, or event based retraining of the ML model or models may be appropriate, to update the model to take account of changes in the radio environment, the type of vehicles for which position is to be estimated, and/or common paths or trajectories, for example during public works or construction. Retraining might be initiated based on a fixed time period or prediction performance measures. Retraining of the model may be carried out using all captured data, using a most recent portion of measurements or using some mixture of more and less recent data.

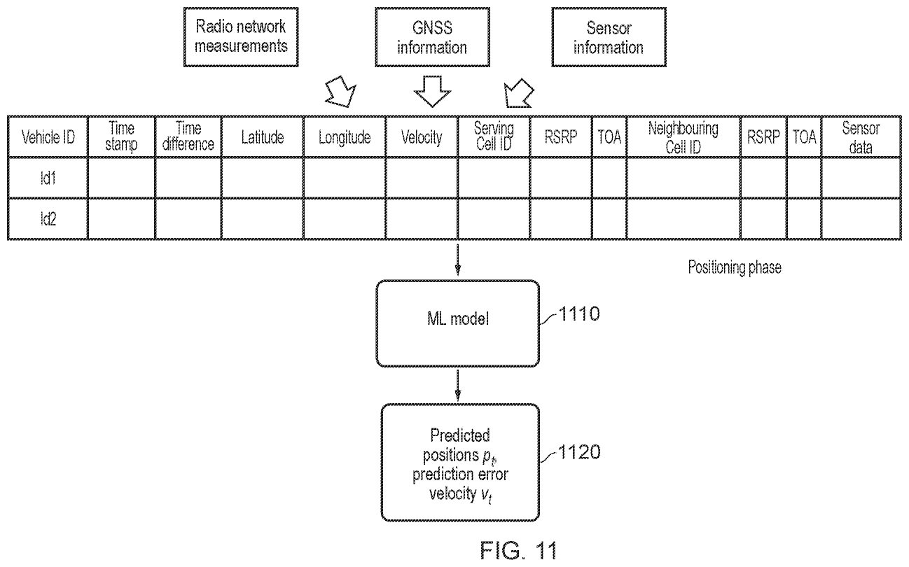

Once the model is trained then a live running or prediction phase can begin. One example of a running phase is illustrated in FIG. 11. Using the model 1110 trained in the training phase, vehicle position can be predicted 1120 based on a position from a previous time stamp and radio measurements provided by the vehicle.

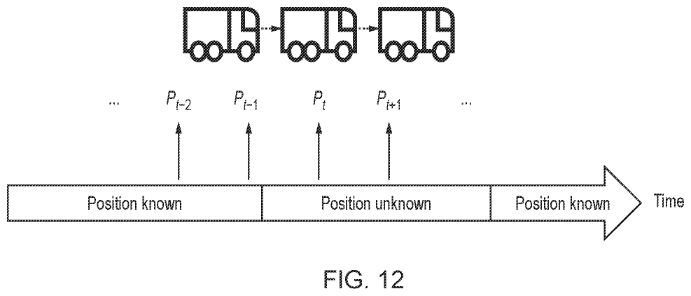

One particular prediction example is illustrated in FIG. 12. Up to the time stamp t−1, the location of the vehicle is available, for example provided by GNSS. From time stamp t, there is no position information available, possibly owing to weak GNSS coverage. Using the machine learning model, the position at time stamp t can be predicted in light of inputs including: known positions up to time t−1, time difference Δt and the radio and sensor measurements at t. At time stamp t+1, the position is predicted using the available inputs: historical positions [symbol] , and pₜ₋₁, estimated position at time stamp t, the time difference Δt and the radio/sensor measurements at t+1.

As discussed above with reference to FIGS. 3c and 3d, an estimated position generated using the ML model may be cross checked against estimated positions from different nodes. For example, a serving node and neighbouring nodes can check similarities between their estimated positions for a vehicle. The serving node can calculate a similarity metric for its outcome and the reported outcome from neighbouring nodes. This similarity check can assist with detecting false outcome reporting from a false base station that may report an incorrect position to a neighbouring node. In a similar manner, the similarity check can be used for detecting false GNSS reports provided to the connected vehicles, including for example in the case of GPS spoofing or GPS manipulation. In such scenarios, the connected vehicles can be warned or disconnected from the GPS network after some time for safety and security reasons.

A connected vehicle may also be disconnected from a GNSS network, or may have its sampling frequency adjusted, in order to achieve energy savings. For example, if the ML model is providing position estimates with an accuracy above a certain threshold, the ML model may take over some of the responsibility for providing positioning information from the GNSS network, providing energy savings for the vehicle. The accuracy of a model can be estimated during its training procedure, and may additionally be checked during a live running phase, when positioning information from a GNSS is available. The threshold for disconnected from GNSS, or adjusting sampling frequency, may be selected based on vehicle or mounted device capabilities. For example, a vehicle or device with high battery constraints and low required positioning accuracy can turn-off GNSS more often than a device with low battery constraint and high accuracy requirement. A vehicle UE can turn-off its GNSS as long as the accuracy of the model is above the threshold. The accuracy of a model can be estimated during its training procedure.

As discussed above, the methods 200 to 500 are performed by a communication network node and training agent respectively. The present disclosure provides a communication network node and training agent which are adapted to perform any or all of the steps of the above discussed methods.

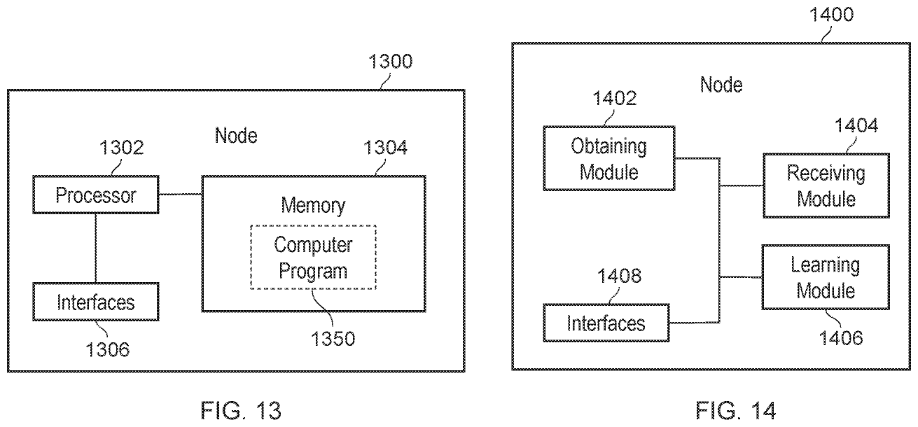

FIG. 13 is a block diagram illustrating an example communication network node which may implement the method 200 and/or 300 according to examples of the present disclosure, for example on receipt of suitable instructions from a computer program 1350. Referring to FIG. 13, the communication network node 1300 comprises a processor or processing circuitry 1302, and may comprise a memory 1304 and interfaces 1306. The processing circuitry 1302 is operable to perform some or all of the steps of the method 200 and/or 300 as discussed above with reference to FIGS. 2 and 3a to 3d. The memory 1304 may contain instructions executable by the processing circuitry 1302 such that the communication network node 1300 is operable to perform some or all of the steps of the method 200 and/or 300. The instructions may also include instructions for executing one or more telecommunications and/or data communications protocols. The instructions may be stored in the form of the computer program 1350. In some examples, the processor or processing circuitry 1302 may include one or more microprocessors or microcontrollers, as well as other digital hardware, which may include digital signal processors (DSPs), special-purpose digital logic, etc. The processor or processing circuitry 1302 may be implemented by any type of integrated circuit, such as an Application Specific Integrated Circuit (ASIC), Field Programmable Gate Array (FPGA) etc. The memory 1304 may include one or several types of memory suitable for the processor, such as read-only memory (ROM), random-access memory, cache memory, flash memory devices, optical storage devices, solid state disk, hard disk drive etc.

FIG. 14 illustrates functional units in another example of communication network node 1400 which may execute examples of the methods 200 and/or 300 of the present disclosure, for example according to computer readable instructions received from a computer program. It will be understood that the units illustrated in FIG. 14 are functional units, and may be realised in any appropriate combination of hardware and/or software. The units may comprise one or more processors and may be integrated to any degree.

Referring to FIG. 14, the communication node 1400 is for estimating a position of a vehicle, wherein the vehicle is operable to connect to the communication network. The communication network node 1400 comprises an obtaining module 1402 for obtaining dynamic state information for the vehicle at a first time in a time sequence, the dynamic state information comprising position information for the vehicle. The communication network node 1400 further comprises a receiving module 1404 for receiving, from the vehicle, communication network information for the vehicle at a second time in the time sequence that is after the first time, wherein the communication network information comprises a result of a measurement carried out by the vehicle on a signal exchanged with the communication network. The communication network node 1400 further comprises a learning module 1406 for using a trained Machine Learning (ML) model to estimate a position of the vehicle at the second time in the time sequence on the basis of the obtained dynamic state information and received communication network information. The communication network node may further comprise interfaces 1408.

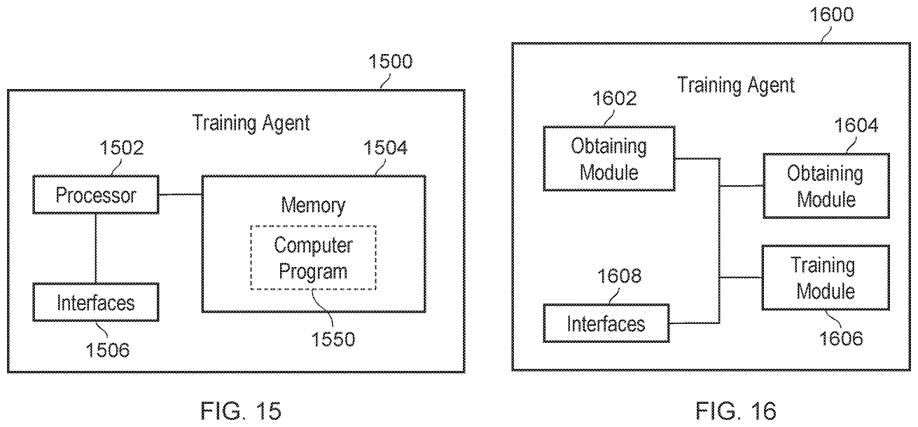

FIG. 15 is a block diagram illustrating an example training agent 1500 which may implement the method 400 and/or 500 according to examples of the present disclosure, for example on receipt of suitable instructions from a computer program 1550. Referring to FIG. 15, the training agent 1500 comprises a processor or processing circuitry 1502, and may comprise a memory 1504 and interfaces 1506. The processing circuitry 1502 is operable to perform some or all of the steps of the method 400 and/or 500 as discussed above with reference to FIGS. 4 and 5a to 5c. The memory 1504 may contain instructions executable by the processing circuitry 1502 such that the training agent 1500 is operable to perform some or all of the steps of the method 400 and/or 500. The instructions may also include instructions for executing one or more telecommunications and/or data communications protocols. The instructions may be stored in the form of the computer program 1550. In some examples, the processor or processing circuitry 1502 may include one or more microprocessors or microcontrollers, as well as other digital hardware, which may include digital signal processors (DSPs), special-purpose digital logic, etc. The processor or processing circuitry 1502 may be implemented by any type of integrated circuit, such as an Application Specific Integrated Circuit (ASIC), Field Programmable Gate Array (FPGA) etc. The memory 1504 may include one or several types of memory suitable for the processor, such as read-only memory (ROM), random-access memory, cache memory, flash memory devices, optical storage devices, solid state disk, hard disk drive etc.

FIG. 16 illustrates functional units in another example of training agent 1600 which may execute examples of the methods 400 and/or 500 of the present disclosure, for example according to computer readable instructions received from a computer program. It will be understood that the units illustrated in FIG. 16 are functional units, and may be realised in any appropriate combination of hardware and/or software. The units may comprise one or more processors and may be integrated to any degree.

Referring to FIG. 16, the training agent 1600 is for training a Machine Learning (ML) model for estimating a position of a vehicle, wherein the vehicle is operable to connect to a communication network. The training agent 1600 comprises a first obtaining module 1602 for obtaining dynamic state information for the vehicle at a plurality of times forming a time sequence over a training period, wherein the dynamic state information comprises position information generated by a satellite positioning system. The training agent 1600 further comprises a second obtaining module 1604 for obtaining communication network information for the vehicle at the plurality of times over the training period, wherein the communication network information comprises a result of a measurement carried out by the vehicle on a signal exchanged with the communication network. The training agent 1600 further comprises a training module 1606 for using the obtained dynamic state information and communication network information to train an ML model for estimating a position of the vehicle. The training agent 1600 may also comprise interfaces 1608.

Aspects of the present disclosure, as demonstrated by the above discussion, provide methods, a communication network node and a training agent that may cooperate to provide an estimated position of a vehicle on the basis of dynamic state information and communication network information. As noted above, positioning for connected vehicles is required for tasks including path-planning, traffic-regulation, collision-avoidance, etc. Although GNSS systems can provide positioning information, GNSS coverage is intermittent. Aspects and examples of the present disclosure propose a procedure according to which machine learning methods may be used to learn a model for estimating position by exploiting features available from a connected vehicle including trajectory, radio-measurements, sensor measurements, evolution of such measurements over time, etc.

Using machine learning and radio measurements from a communication network according to examples of the present disclosure can be of particular assistance for situations in which GNSS positioning is unreliable or not available. Methods according to the present disclosure provide positioning information when GNSS cannot be relied upon (owing to lack of coverage, GNSS jamming, etc.) without requiring extensive exploration of map information, and the associated high storage requirements and complex image processing. It will be appreciated that the ML model according to examples of the present disclosure may be trained using measurement data or a combination of measurements and deterministically known dynamic models. In addition, the ML model can be regularly retrained to maintain satisfactory positioning accuracy. Training data for the machine learning model can be collected whenever GNSS information is available, and a range of different radio measurement reports are already provided by vehicles operable to connect to communication networks and are thus available for use in training and running of the ML model. When accuracy of the ML model position estimate is high, examples of the present disclosure allow for disconnection from GNSS, or reduction in sampling frequency, thus offering increased energy efficiency. Examples of the present disclosure may be used in combination with a wide range of existing positioning methods, such as filtering, GNSS based methods, etc. which methods may be used to further refine position estimation provided by the ML model.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality and a single processor or other unit may fulfil the functions of several units recited in the claims. Any reference signs in the claims shall not be construed so as to limit their scope.

1. A computer implemented method for estimating a position of a vehicle, wherein the vehicle is operable to connect to a communication network, the method, performed by a node of the communication network, comprising:
obtaining dynamic state information for the vehicle at a first time in a time sequence, the dynamic state information comprising position information for the vehicle;
receiving from the vehicle communication network information for the vehicle at a second time in the time sequence that is after the first time, wherein the communication network information comprises a result of a measurement carried out by the vehicle on a signal exchanged with the communication network; and
using a trained Machine Learning, ML, model to estimate a position of the vehicle at the second time in the time sequence on the basis of the obtained dynamic state information and received communication network information.

2. The method according to claim 1, wherein obtaining dynamic state information for the vehicle at the first time in the time sequence comprises receiving the dynamic state information from the vehicle, the dynamic state information comprising position information generated by a satellite positioning system.

3. The method according to claim 2, wherein the dynamic state information further comprises sensor information generated by a sensor on the vehicle.

4. The method according to claim 1, wherein obtaining dynamic state information for the vehicle at the first time in the time sequence comprises retrieving an estimated position of the vehicle at the first time in the time sequence, the estimated position of the vehicle at the first time in the time sequence generated during a previous iteration of the computer implemented method.

5. The method according to claim 1, wherein using a trained ML model to estimate a position of the vehicle at the second time in the time sequence on the basis of the obtained dynamic state information and received communication network information comprises:
assembling an input feature vector from the obtained dynamic state information and received communication network information; and
inputting the input feature vector to the trained ML model;
wherein the ML model has been trained using training data assembled from dynamic state information and communication network information received from the vehicle over a training period, and wherein the dynamic state information received from the vehicle over the training period comprises position information generated by a satellite positioning system.

6. The method according to claim 5, wherein the assembling an input feature vector from the received information comprises including in the input feature vector a time difference between the first time in the time sequence and the second time in the time sequence.

7. The method according to claim 1, wherein using a trained ML model to estimate a position of the vehicle at the second time in the time sequence on the basis of the obtained dynamic state information and received communication network information comprises using a combined positioning model to generate an estimated position of the vehicle, wherein the combined positioning model is configured to accept dynamic state information and communication network information as inputs to the model.

8. The method according to claim 1, wherein using a trained ML model to estimate a position of the vehicle at the second time in the time sequence on the basis of the obtained dynamic state information and received communication network information comprises:
using a dynamic positioning model to generate a first estimated position of the vehicle, wherein the dynamic positioning model is configured to accept dynamic state information as inputs to the model;
using an observation positioning model to generate a second estimated position of the vehicle, wherein the observation positioning model is configured to accept communication network information as inputs to the model; and
combining the first and second estimated positions to generate an output estimated position of the vehicle.

9. The method according to claim 1, wherein using a trained ML model to estimate a position of the vehicle at the second time in the time sequence on the basis of the obtained dynamic state information and received communication network information comprises using a filtering algorithm to reduce error in an estimated position of the vehicle.

10. The method according to claim 1, wherein using a trained ML model to estimate a position of the vehicle at the second time in the time sequence on the basis of the obtained dynamic state information and received communication network information comprises:
using a dynamic state transition model to generate potential estimated positions of the vehicle;
using an observation model to refine the generated potential estimated positions; and
generating an output estimated position of the vehicle from the refined potential estimated positions.

11. The method according to claim 1, further comprising:
sending the estimated position of the vehicle at the second time in the time sequence to the vehicle.

12. The method according to claim 1, further comprising:
obtaining an estimated position of the vehicle at the second time in the time sequence from another node in the communication network;
calculating a similarity score between the obtained estimated position of the vehicle at the second time in the time sequence from the other node and the estimated position of the vehicle at the second time in the time sequence from the trained ML model; and
if the calculated similarity score is below a first threshold value, performing at least one of:
initiating retraining of the ML model;
reporting an anomaly.

13. The method according to claim 1, further comprising:
receiving, from the vehicle, dynamic state information for the vehicle at the second time in the time sequence, wherein the dynamic state information comprises position information generated by a satellite positioning system;
calculating a similarity score between the position information generated by a satellite positioning system for the vehicle at the second time and the estimated position of the vehicle at the second time based on the received information; and
if the calculated similarity score is below a second threshold value, performing at least one of:
initiating retraining of the ML model;
reporting an anomaly.

14. The method according to claim 13, wherein the dynamic state information received from the vehicle for the second time in the time sequence further comprises sensor information generated by a sensor on the vehicle.

15. The method according to claim 13, further comprising:
obtaining an estimated position of the vehicle at the second time in the time sequence from another node in the communication network; and
if the calculated similarity score is below a second threshold value:
using the obtained estimated position of the vehicle at the second time in the time sequence from another node in the communication network to determine whether to initiate retraining of the ML model or report an anomaly.

16. The method according to claim 13, further comprising:
if the calculated similarity score is above a third threshold value, performing at least one of:
instructing the vehicle to reduce a sampling frequency with which the vehicle obtains position information from the satellite positioning system; or
instructing the vehicle to cease obtaining position information from the satellite positioning system for a period of time.

17. A computer implemented method for training a Machine Learning, ML, model for estimating a position of a vehicle, wherein the vehicle is operable to connect to a communication network, the method, performed by a training agent, comprising:
obtaining dynamic state information for the vehicle at a plurality of times forming a time sequence over a training period, wherein the dynamic state information comprises position information generated by a satellite positioning system;
obtaining communication network information for the vehicle at the plurality of times over the training period, wherein the communication network information comprises a result of a measurement carried out by the vehicle on a signal exchanged with the communication network; and
using the obtained dynamic state information and communication network information to train a ML model for estimating a position of the vehicle.

18. The method according to claim 17, wherein the dynamic state information further comprises sensor information generated by a sensor on the vehicle.

19.-27. (canceled)

28. A communication network node for estimating a position of a vehicle, wherein the vehicle is operable to connect to the communication network, the node comprising processing circuitry configured to cause the node to:
obtain dynamic state information for the vehicle at a first time in a time sequence the dynamic state information comprising position information for the vehicle;
receive from the vehicle communication network information for the vehicle at a second time in the time sequence that is after the first time, wherein the communication network information comprises a result of a measurement carried out by the vehicle on a signal exchanged with the communication network; and
use a trained Machine Learning, ML, model to estimate a position of the vehicle at the second time in the time sequence on the basis of the obtained dynamic state information and received communication network information.

29. (canceled)

30. A training agent for training a Machine Learning, ML, model for estimating a position of a vehicle, wherein the vehicle is operable to connect to a communication network, the training agent comprising processing circuitry configured to cause the training agent to: obtain dynamic state information for the vehicle at a plurality of times forming a time sequence over a training period, wherein the dynamic state information comprises position information generated by a satellite positioning system;
obtain communication network information for the vehicle at the plurality of times over the training period, wherein the communication network information comprises a result of a measurement carried out by the vehicle on a signal exchanged with the communication network; and
use the obtained dynamic state information and communication network information to train a ML model for estimating a position of the vehicle.

31. (canceled)
